(19) United States
(12) Patent Application Publication
(10) Pub. No.: US 2018/0304879 A1
(43) Pub. Date: Oct. 25, 2018

(54) BRAKE LINE BLEEDING DEVICE

(71) Applicant: Jeffry G. Holmes, Luther, MI (US)

(72) Inventor: Jeffry G. Holmes, Luther, MI (US)

(21) Appl. No.: 16/022,920

(22) Filed: Jun. 29, 2018

Related U.S. Application Data
(63) Continuation of application No. 15/182,177, filed on Jun. 14, 2016.
(60) Provisional application No. 62/252,150, filed on Nov. 6, 2015.

(51) Int. Cl. B60T 17/22

(52) U.S. Cl. CPC B60T 17/223

(57) ABSTRACT

A brake line bleeding device including a main body with a cylinder and an extending stem. The cylinder is supported at a fixed location within the vehicle, such as upon the steering wheel. The stem is secured, at an end opposite the cylinder, to the brake pedal. A pressurized conduit extends from a source and is communicated to an input of a powered manifold mounted to the cylinder. A two position valve is integrated into the powered manifold and, upon receipt of an input signal, is actuated by a control mechanism within the manifold to switch between first and second outlet conduits extending from the manifold and in order to communicate the pressurized source to respective forward and rearward locations of the cylinder. In this fashion, pressurized fluid or airflow is alternatively communicated to opposite ends of the cylinder in order to reciprocally drive the stem in a bi-linear fashion relative to the housing, such as in order to successively pump the brake in a brake fluid servicing or bleeding operation.

### CROSS REFERENCE TO RELATED APPLICATIONS

The present application is a continuation-in-part application which claims the priority of U.S. Ser. No. 15/182,177 filed Jun. 14, 2016. The '177 application claims the priority of U.S. Ser. No. 62/252,150, filed Nov. 6, 2015, the contents of which are incorporated herein in their entirety.

### FIELD OF THE INVENTION

The present invention discloses a brake line bleeding device utilized by a single person remotely from either inside or outside of a vehicle to which the device is mounted. The device includes a main body with a cylinder and an extending stem. The cylinder is supported at a fixed location within the vehicle, such as upon the steering wheel. The stem is secured, at an end opposite the cylinder, to the brake pedal. A pressurized conduit, such as extending from a compressor or other compressed air or fluid tank, is communicated to an input of a powered manifold mounted to the cylinder or associated outer housing. A two position, typically solenoid or other controlling mechanism, operated gate or check valve is integrated into the powered manifold and, upon receipt of a signal, is actuated within the manifold to switch between first and second outlet conduits extending from the manifold to respective forward and rearward locations of the cylinder. In this fashion, pressurized airflow is alternatively communicated to opposite ends of the cylinder in order to reciprocally drive the stem in bi-linear fashion relative to the housing in order to successively pump the brake in a brake fluid servicing operation.

### BACKGROUND OF THE INVENTION

The prior art is documented with numerous examples of brake pedal actuator (bleeding devices) the purpose for which being the ability of a single user to bleed a vehicles brakes from a location outside of the vehicle. Among these are included the patent references to Rhodenizer, U.S. Pat. No. 6,131,712, Campbell, US 2008/0011566, Youngers, U.S. Pat. No. 5,299,668, Hare, U.S. Pat. No. 6,044,671, and Whitt, US 2007/0012533.

Typical of the prior art is the brake pedal actuator of Rhodenizer which teaches a brake pedal actuator having a tubular member and a stem telescopically mounted in the tubular member. A J-shaped hook is mounted on the stem for attachment to a segment of a steering wheel of a vehicle. A pedal clamping mechanism is mounted on the tubular member for attachment to the brake pedal of the vehicle. A handle is mounted on the tubular member for allowing a manual pushing and pulling of the brake pedal by a user standing outside the vehicle.

In another aspect of the invention, the actuator in Rhodenizer has a wedge-type locking sleeve and nut affixed to the clamping mechanism for selectively locking the mechanism and for preventing a loosening or clapping of the latching mechanism when the brake pedal is manually actuated back and forth. In a further aspect of the present invention, the brake pedal actuator comprises a ring which is movably mounted on the stem and restrictively positional along the stem. When the brake pedal actuator is in use in a still mode, the position of the ring and the end of the tubular member are usable for monitoring a creeping movement of a brake pedal under a load from the actuator.

Additional to the Rhodenizer U.S. Pat. No. 6,131,712 reference, the other cited references are all of a similar nature (all within the same class and subclass and all directed to a brake bleeding device which attaches between a pedal and some interior location of the vehicle. Among these, Youngers teaches a supply line 22 and attachment fitting 23 engageable with a pressurized source (tank, compressor) which drives the actuator 10 hooked between the steering wheel and break pedal via an intermediate pressure control assembly 24.

Finally, the commercial disclosure for the Pedal Pumper is noted and appears similar to the Youngers patent with an expansible cylinder attached between the vehicle steering wheel and the brake pedal, a fluid line extending from a pressurized input location of the cylinder to a remote location (presumably again compressor or the like).

### SUMMARY OF THE INVENTION

As previously described, the present invention discloses a brake line bleeding device capable of being utilized by a single person positioned either inside or remotely from outside of a vehicle within which the device is mounted. The device includes a main body with a cylinder and an extending stem. The cylinder is supported at a fixed location within the vehicle, such as upon the steering wheel. The stem is secured, at an end opposite the cylinder, to the brake pedal.

A pressurized conduit, such as extending from a compressor or other compressed air tank, is communicated to an input of a powered manifold mounted to the cylinder or associated outer housing. A two position gate or check valve is integrated into the powered manifold and, upon receipt of a signal, is actuated by a control mechanism including such as a solenoid or other electrically driving component located within the manifold, in order communicate the pressurized air/fluid input in switching fashion between first and second outlet conduits extending from the manifold to respective forward and rearward locations of the cylinder.

Power to the manifold and its control mechanism can be provided by a vehicle charger extension which extends from the control mechanism and plugs into the vehicle charger (also known as a cigarette lighter). In this fashion, pressurized airflow is alternatively communicated to opposite ends of the cylinder in order to reciprocally drive the stem in bi-linear fashion relative to the housing in order to successively pump the brake in a brake fluid servicing or bleeding operation.

The ability to push/pull the brake pedal in this fashion contributes to faster effective bleeding of the brakes, and as opposed to a situation such as in the Prior Art in which the actuating device only pushes in a given direction in timed and sequenced fashion, with released pressure acting on the brake pedal between depressing actuation during which pedal gradually retracts as a result of the internal counter pressures within the brake line acting upon it. In a further use application, the reverse/pulling aspect of the device can create sufficient holding forces between the steering wheel and brake pedal, such holding the wheel in place and preventing inadvertent rotation thereof during straightening the front end of the vehicle.

### BRIEF DESCRIPTION OF THE DRAWINGS

Reference will now be made to the attached drawing, when read in combination with the following detailed description, wherein like reference numerals refer to like parts throughout the several views, and in which:

FIG. 1 is an environmental view illustrating the pedal attachment device in use with a vehicle having its brake lines bled;

FIG. 2 is an overall view of the pedal attachment device according to the present invention;

FIG. 3 is an environmental view illustrating the pedal attachment device according to a further variant and including a built in combination powered manifold and dual position valve which is actuated to communicate the pressurized input with either of the opposite cylinder end communicated outputs for reciprocally driving the stem;

FIG. 4 is an illustration of the pedal attachment device of FIG. 3 and further illustrating the bracketry for supporting between the steering wheel and the pedal for effectively pumping/bleeding the brakes and again depicting the power source in the form of a plug-in vehicle charger; and

FIG. 5 is an enlarged illustration taken in cutaway along line 5-5 of FIG. 4 and depicting one possible and non-limiting example of an interior component structure of the power module, such including the provision of a solenoid or other electrically control actuated valve for providing two position switching between the pair of outlet conduits extending to the cylinder on opposite sides of the interiorly supported plunger associated with the reciprocally driven stem.

### DETAILED DESCRIPTION OF THE PREFERRED EMBODIMENTS

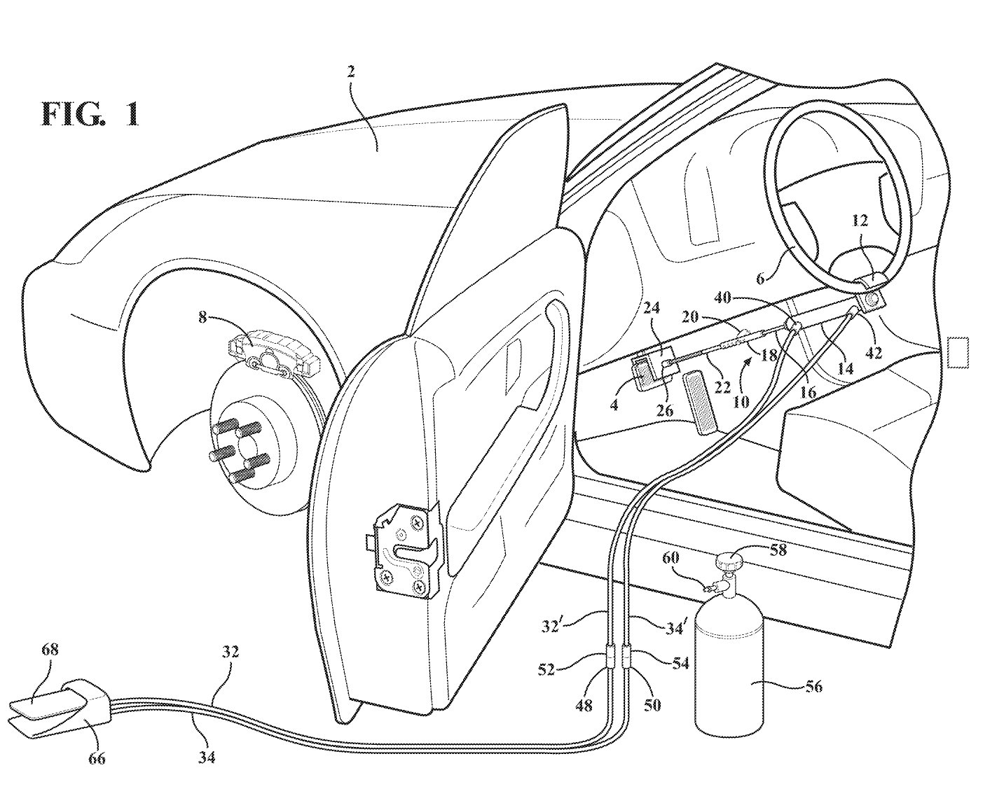

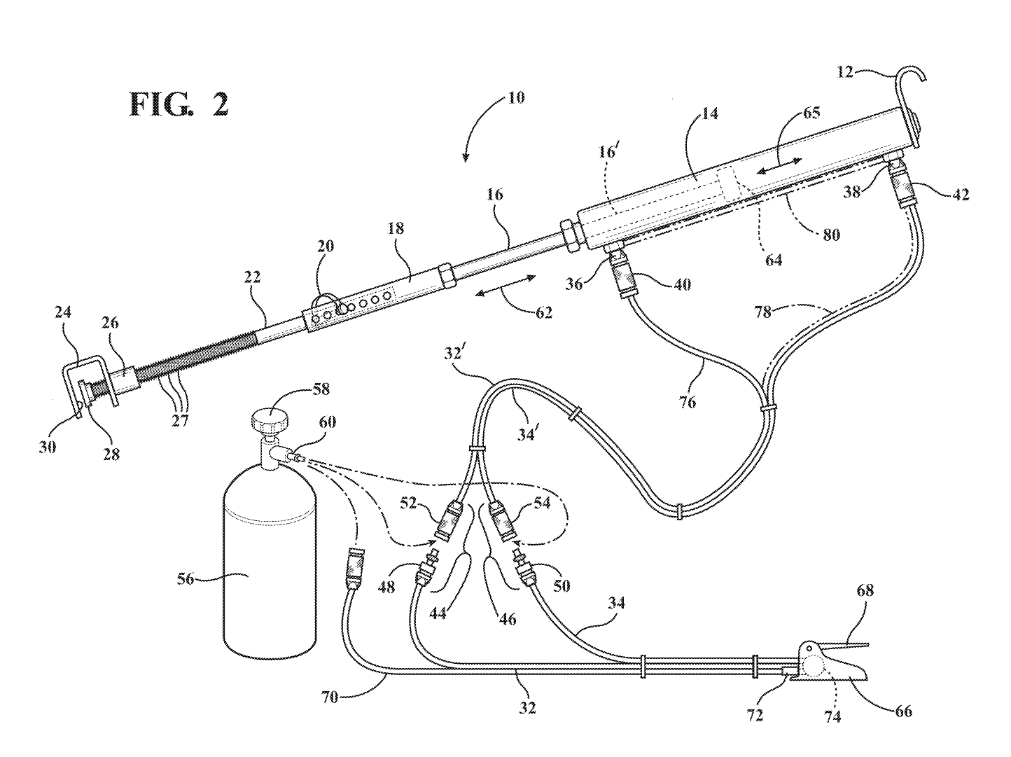

Referring to FIGS. 1 and 2, the present invention discloses a brake line bleeding device, see generally at 10, which is capable of being utilized by a single person remotely from outside a vehicle, represented at 2 in FIG. 1, with which the device is utilized. As will be further described, the present invention is an improvement over prior art brake bleeding devices in that it provides for improved bi-directional driving motion of the cylinder stem an associated linkages for the purpose of remotely and repetitively depressing and releasing the brake pedal, further at 4 in FIG. 1, in order to bleed the vehicle brakes during servicing by a single individual operating on the vehicle at a location remote from its interior (e.g. underneath the vehicle in proximity to the brake lines and in order to facilitate draining of the fluid).

With additional reference to FIG. 2, the device 10 includes a main elongated and length extensible body which is secured between the vehicle steering wheel, further at 6 in FIG. 1 by an arcuate shaped hook 12 which is secured to a first end of the device, and the brake pedal 4. The main attachable body is further defined as including each of a pressurized (air) cylinder 14, and air cylinder shaft 16 (projecting from the cylinder 14), a length adjustable sleeve 18 with locking pin 20 secured to an end of the shaft 16, and an end extending shaft 22 which in turn supports such as a brake pedal engaging portion, such including any of a “U” shaped brake pedal mounted bracket 24, a otherwise configured portion which can be similar to the steering wheel engaged hook and which is secured to the end of the stem linearly displaceable stem and is adapted to being engaged to the vehicle brake pedal 4 in the manner to be described.

As previously indicated, the steering wheel clamp 12 is shown and which extends from a first (proximal) end of the cylinder 14 for mounting to the vehicle steering wheel 6 by engaging a wheel location against its inner contoured side. At the opposite end, the “U” shaped brake pedal mounted bracket or hook 24 includes an interiorly collar mount, see at 26 which is secured to the bracket 24, and through which is linearly received the end most exteriorly threaded and extending portion (see threads 27) of the shaft 22.

In one non-limiting variant, an end abutment 28 can be provided and includes any of a free rotating pedestal or end cap, provided upon the end face of the extended shaft 22 and so that it is threadably adjusted through the open collar mount 26 and into the interior of the “U” shaped bracket at which it comes into contact with the outer facing surface of the pedal 4. In a further variant, the “U” shaped bracket interior can be provided more generally as a hook without the open collar mount through which the stem projects, and so that the open interior “U” bracket or other hook shaped engaging member sets over the upper extending edge of the brake pedal and the linear adjusting aspects of the cylinder and sleeve provide the necessary travel motion of the bracket 24 into push/pull bi-directionally actuating contact with the brake pedal.

In use, and upon removing the locking pin 20 and readjusting the non-threaded and linearly displaceable portion of the shaft 22 by realigning its length relative to the sleeve 18 (via reseating the pin 20 into length defined apertures in the sleeve 18 which may align with additional apertures configured into the shaft 22), the present invention allows for varying the overall length of the body for accommodating the given dimension between the vehicle steering wheel and its brake pedal, prior to engagement and application of the pressurized fluid source (such including any of an air/pneumatic or liquid/hydraulic), and so that the brake pedal bracket 24 is positioned for sandwiching the vehicle brake pedal between selected inner face 30 and the opposing end face of the length adjustable end abutment or cap 28. To this end, the shaft can also be locked into position relative to both the adjusting sleeve 18 as well as the collar mount 26 and it is also envisioned that other structure beyond that described herein can be provided for establishing an overall length extending stem or shaft (collectively incorporating the features depicted in non-limited fashion in the illustrations) projecting from the drive cylinder 14 in order to alternately depress and release the vehicle brake pedal.

A pair of hoses are provided, each having first and second interconnecting lengths identified at 32/34 and 32′/34′. The second length portions 32′/34′ of the hoses extend from opposite end fittings 36 and 38 associated with the cylinder 14, and which generally correspond to front and rear ends of the cylinder. As further shown, a pair of pressure regulators 40 and 42 are optionally provided located at proximate end locations of the hose portions 32′/34′ at the cylinder connections 36/38.

Intermediate quick connector attachments, see subassemblies depicted at 44 and 46 with first 48/50 and second 52/54 interconnecting attachments, are provided for interconnecting the first 32/34 and second 32′/34′ hose portions together. In one non-limiting variant, and upon separating a given pair of the quick connect 48/52 or 50/54, the given coupling portion 52 or 54 is engaged to a remote pressurized source (see pressurized tank or compressor 56 with top open/close valve 58 and nozzle outlet 60 for receiving the connector 52/54), this accomplished in alternative fashion in order to selectively pressurize a given one of the selected fluid line portions 32′ or 34′.

In this fashion, the hose portions 32′ or 34′ are alternately actuated in order to drive the stem 16 and associated end fittings in either of bi-directional fashion (arrow 62) in order to depress and subsequently release the brake pedal 4. As is further understood, and without limitation, the cylinder interior 14 can be configured with a bi-directional movable disk (shown in phantom at 64 within the channeled interior of the cylinder 14 in supported end communication with portion 16′ of the stem extending within the cylinder interior). The disk 64 can exhibit a sealed outer perimeter or the like so that corresponding bi-directional interior movement of the disk within the cylinder (see arrow 65 in FIG. 2 is accomplished by pressurized fluid (air) entering either of the subdivided chambers in the interior of the cylinder which are on opposite sides of the linearly displaceable and edge gasket sealed disk 64 and which in turn extend or retract the sleeve (see cylinder interior portion 16′ and projecting portion 16) to push or pull on the pedal 4 via the end mounted “U” bracket or hook 24.

As further shown, the first hose portions 32/34 can also extend to an end most positioned foot pedal 66 which can operate independently of or in cooperation with the pressurized tank 56 or compressor, for delivering the pressurized input for driving the cylinder, sleeve and brake pedal attachment in the manner described.

For purposes of the present invention, it is understood that the basic two way displacement operation of the cylinder 16 can be accomplished in one non-limiting application by only the second hose portions 32′/34′ in alternating engagement with the pressurized fluid source 56 (again via quick connect portions 52 or 54 in engagement with the nozzle 60 of the source 56 (again air tank or compressor). The foot pedal 66, with upper pivoting arm or actuating portion 68, such as is located in proximity to the brake pads 8 (FIG. 1) can be alternatively engaged to the lines in the manner depicted in FIG. 1 (such as by a single individual replacing the pads) and, upon separating a selected pair of quick connect assemblies 44 or 46 (again individual pairs of couplings 48/52 or 50/54) can operate on a foot pedal pressurizing arrangement for driving the cylinder without the need of the external pressurizing source 56.

In a further non-limiting embodiment, the pressurized fluid source 56 can alternatively or additionally include a separate line or conduit 70 which connects to the nozzle 60 at a first end and, at an opposite second end, to a separate fluid input plug or port 72 of the foot pedal 66 which is in turn in selective communication with either of (or concurrently both) the hose portions 32 or 34. In one configuration a selected pair of quick connects 48/52 or 50/54 can be separated to thereby interrupt flow through that line, resulting in pressurized flow only through the other connected line.

In a further configuration, the quick connects between hose portions 32/34 and 32′/34′ can be rendered optional (thereby rendering the pairs of interconnected hose portion as a single pair of extending hoses between the foot pedal and the cylinder), this by integrating a switch 74 integrated into the fluid communicating interior of the foot pedal 66 which selectively fluidly communicates the pressurized flow through line 70 with a selected one of the hoses 32/34.

The split mounting arrangement of the hose portions 32′/34′ in respective fashion to the opposite end ports 36/38 of the cylinder 14 can also be substituted in a further non-limiting variant by reconfiguring/removing indicated split portion 76 (FIG. 2) to extend instead as shown at 78 in bound fashion to the rear end of the cylinder 14 consistent with the positioning of the end port 38. In this alternate configuration, an elongated and linear attachment 80 extends between the cylinder end ports 36/38 (along either of the interior or exterior of the cylinder, and in order to communicate the flow from line 78 to the port 36, in this application for selective pressurized introduction into the interior of the cylinder and for retracting the sleeve 16 and pulling the pedal 4.

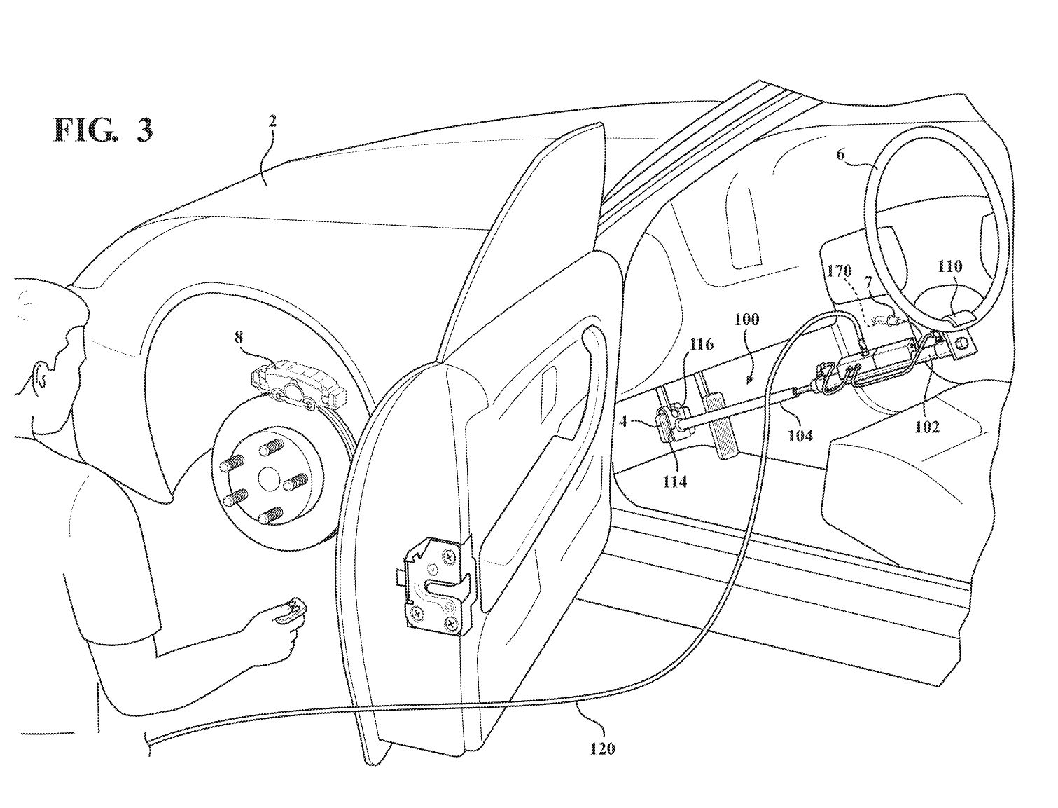

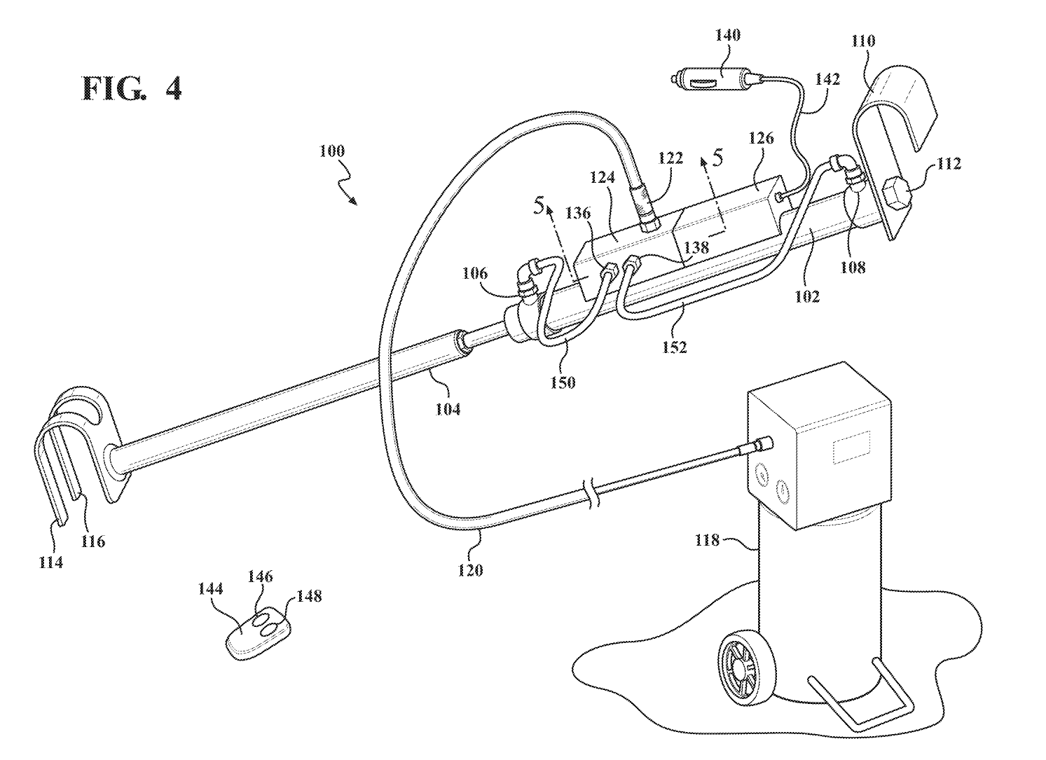

Referring now to FIG. 3, an environmental view is shown generally at 100 illustrating the pedal attachment device according to a further variant. As is also depicted in the enlarged view of FIG. 4, the device 100 is similar in respects to that depicted FIGS. 1-2 and includes a cylinder 102 which supports a bi-directionally displaceable stem 104. Without limitation, the stem 104 can be reconfigured such as similar to the shaft and support structure of FIGS. 1-2. Similar to the partial phantom view of FIG. 2, an interior of the cylinder includes a plunger seal or other disk element (previously shown at 64) which is mounted to the inner end of the stem 104 and, in response to pressurized air/fluid communicated to each of forward 106 and rearward 108 inputs to the cylinder on opposite sides of the plunger, result in a bi-directionally linear reciprocating motion as shown at 62 in FIG. 2.

Similar to depicted at 12 in FIG. 1, a first bracket 110 (such having a looped or curved shape) is shown which is mounted to an end of the cylinder (see attachment bolt 112) for supporting in suspended or cradled fashion over a location of the vehicle steering wheel 6, it being further understood that other variants of the invention also envision alternatively securing the cylinder end of pedal attachment device to any other suitable vehicle interior location not limited to a seatback, headrest or other location. A second bracket is mounted to an extending end of the stem 104 opposite the cylinder 102, the second bracket having a likewise looped or reverse bent configuration with a pair of spaced apart portions 114 and 116 such that these cradle or suspend over the top of the brake pedal 4 (see again FIG. 4).

A remote pressured air for fluid source (the present invention contemplating variants in which any of an air compressor, pre-charged or pre-pressurized tank is used) is provided at 118 (FIG. 4) and supplies pressurized air through a hose or conduit 120 to an input location 122 of a manifold which is shown secured to the cylinder 102 however can alternatively be positioned at any proximate supporting location. As further shown, the non-limiting and depicted version of the manifold includes a dual position valve section 124 to which the pressurized input 122 connects, along with an adjoining and control actuating or solenoid section 126.

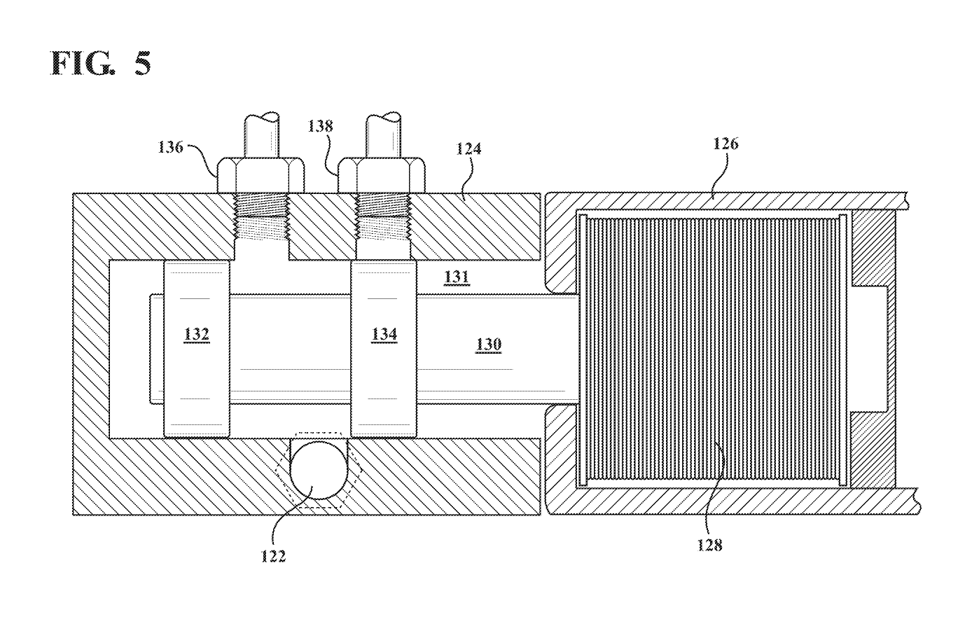

Both the valve section 124 and control/solenoid section 126 of the manifold include a housing which, as shown, can be constructed of a similar durable material not limited to a metal as with the cylinder, stem and brackets. As further shown in FIG. 5, a solenoid 128 is shown incorporated into the associated control section 126, this communicating via a shaft or other control linkage 130 extending into an open interior spaced (at 131), and within which are arranged a pair of linearly supported and displaceable valve or seat portions 132 and 134.

The valve section 124 of the manifold further includes one non-limiting version of a two position switching element, in the illustrated version depicted as the linkage 130 and associated seats 132/134 which are depicted in communication with a pair of outlets 136 and 138, FIG. 5 depicting the first outlet 136 unseated (fluidly communicated with the common input 122) by virtue of the seat 132 displaced away from sealing contact with the outlet 136 whilst the other seat 134 covers or seals the second outlet (138). Variations of the design shown can also envision the solenoid, linkage and seat being redesigned or simplified, such as to provide a single linearly displaceable seat for switching between the outlets 136/138 and in such as fashion as to permit the common pressure input to be communicated to either of the outlets.

It is also envisioned that the linear seat configuration shown can be further substituted by any type of check, gate or other valve construction which can be powered by the solenoid or any related control mechanism (such further powered in the illustrated embodiment by a portable car charger 140 (FIG. 4) which is communicated to the solenoid 128 (or other electrically powered variant) of the manifold control section 126. The portable charger 140 includes such as a cigarette lighter plug which is engaged with the vehicle plug in port (see at 7 in FIG. 1) with a cord 142 extending from the plug to the control section 126, it being further understood that associated electro-mechanical components as is are known in the art are incorporated into the control section 126 in order to operate the associated linkage 130 and seats 132/134 as shown as well as any variant of a two-position valve structure for rapidly and effectively communicating the pressurized input 122 in alternating fashion with the outputs 136/138.

FIG. 4 also depicts a battery operated fob or other remote device, see at 144, such as which can include any arrangement of buttons or press pads (a pair shown at 146 and 148 as representatively depicted). Upon depressing a button (the fob can also include a single button variant) a wireless instruction or signal is provided to the solenoid 128 (via a receive incorporated into the integrated electrically actuating control structure contained within the manifold control section 126), and in order to actuate the two position linkage, check/gate or other structure integrated into the valve section 124, in order to quickly and reciprocally communicate the pressurized air/fluid input to the outputs 136138. Without limitation, the fob 144 can be substituted with any wired or wireless switch or other actuator, such as which can be built into the pedal attachment device.

A pair of output hoses (also pressure conduit sections) are depicted at 150 and 152, these extending from each of the outputs 136 and 138 to the previously described cylinder inputs 106 and 108 and in order to rapidly communicate the pressurized air or other fluid to opposite sides of the stem interior plunger (again at 64 in FIG. 2) in order to rapidly extend and retract the stem 104 in order to successively pump and relax the brakes in such as a brake bleeding operation.

As previously described, the ability to push/pull the brake pedal in the manner provided for by the present invention contributes to faster effective bleeding of the brakes, and as opposed to a situation such as in the Prior Art in which the actuating device only pushes in a given direction in timed and sequenced fashion, with released pressure acting on the brake pedal between depressing actuation during which pedal gradually retracts as a result of the internal counter pressures within the brake line acting upon it. In a further use application, the reverse/pulling aspect of the device can create sufficient holding forces between the steering wheel and brake pedal, such holding the wheel in place and preventing inadvertent rotation thereof during straightening the front end of the vehicle associated with a front end alignment operation.

Having described our invention, other and additional preferred embodiments will become apparent to those skilled in the art to which it pertains, and without deviating from the scope of the appended claims. Without limitation, this can include the reconfiguration of the cylinder and associated fluid lines for use with a hydraulic (liquid) based pressurized source and as an alternative to a pneumatic based system as described and illustrated. It is also envisioned that the attachable device can be differently shaped from that shown without departing from the scope of the inventive concept.

We claim:

1. A device for reciprocally actuating a vehicle brake pedal in alternating depress and retract fashion for the purpose of bleeding its brake lines, said device comprising:
a cylinder from which supports a bi-direction displaceable stem, a plunger connected to said stem and supported within said cylinder;
said cylinder adapted to engage an interior supporting location of the vehicle;
said stem extending from said cylinder and a bracket at an end of said stem adapted to secure to the brake pedal;
a manifold mounted to said cylinder and receiving a pressurized air or other fluid input at an input;
a switching element integrated into said manifold for selectively communicating the input with either of first and second outputs;
a pair of conduits extending from said first and second outputs and connected to input locations of said cylinder on opposite sides of said plunger;
upon receipt of a signal, said switching element being actuated by a control mechanism to switch between said first and second outlet conduits in order to reciprocally drive said plunger, stem, and brake pedal.

2. The device as described in claim 1, said stem further comprising a length adjustable sleeve with locking pin secured to an end thereof.

3. The device as described in claim 1, further comprising a first bracket extending from said cylinder and adapted for securing to a vehicle steering wheel, a second bracket extending from said end of said stem opposite said cylinder and adapted for securing to the brake pedal.

4. The device as described in claim 3, each of said first and second brackets further comprising a curved or reverse shaped construction.

5. The device as described in claim 1, said first and second input locations of said cylinder further comprising end port fittings for receiving said output lines and corresponding to front and rear ends of said cylinder.

6. The device as described in claim 8, said pressurized input further comprising any of a pressurized tank or compressor.

7. The device as described in claim 1, said manifold further comprising a dual position valve section to which said pressurized input connects, along with an adjoining and control actuating section.

8. The device as described in claim 7, said control actuating section further comprising a solenoid.

9. The device as described in claim 8, further comprising said solenoid communicating, via a shaft extending into an open interior spaced of said valve section, with a seat portion.

10. The device as described in claim 9, said seat portion further comprising first and second seat portions in linearly supported and spaced apart fashion upon said shaft.

11. The device as described in claim 8, further comprising a portable charger which is adapted to engaged a plug in port within the vehicle for communicating power to said solenoid.

12. The device as described in claim 8, further comprising a battery operated remote device which, upon depressing a button associated therewith, provides a wireless instruction or signal to said solenoid in order to actuate said switching element.
